(19) United States
(12) Patent Application Publication
(10) Pub. No.: US 2025/0051533 A1
(43) Pub. Date: Feb. 13, 2025

(54) HARD COAT FILM

(71) Applicant: NIPPON PAPER INDUSTRIES CO.,LTD., Tokyo (JP)

(72) Inventors: Takeshi HOTTA, Tokyo (JP); Yusuke SUGIYAMA, Tokyo (JP); Ryo KOIKE, Tokyo (JP); Yuki YOKOI, Tokyo (JP); Eisuke SAKASHITA, Tokyo (JP)

(73) Assignee: NIPPON PAPER INDUSTRIES CO.,LTD., Tokyo (JP)

(21) Appl. No.: 18/722,285

(22) PCT Filed: Dec. 19, 2022
(86) PCT No.: PCT/JP2022/046669

§ 371 Date: Jun. 20, 2024

(30) Foreign Application Priority Data
Dec. 21, 2021 (JP) 2021-207444
Dec. 21, 2021 (JP) 2021-207445
Dec. 21, 2021 (JP) 2021-207446

(51) Int. Cl. C08J 7/046; C08J 7/04; C08J 7/043; C08J 7/06; C08J 7/12; C08K 3/36; C08K 5/3417; C08K 5/3475

(52) U.S. Cl. CPC C08J 7/046; C08J 7/042; C08J 7/043; C08J 7/065; C08J 7/123; C08K 3/36; C08K 5/3417; C08K 5/3475; C08J 2423/02

(57) ABSTRACT

A hard coat film excellent in initial adhesion and light-resistance adhesion between an easy-bonding layer and a hard coat layer on a cycloolefin polymer-based film. The hard coat film includes a hard coat layer containing an ultraviolet curable resin, an ultraviolet absorbing agent, and dye being stacked on at least one surface of a cycloolefin polymer-based film via an easy-bonding layer including ultraviolet curable resin containing inorganic fine particles, and has: a thickness of the easy-bonding layer is 0.1 to 2.0 μm; a thickness of the hard coat layer 1.0 to 10 μm; residual rates of the hard coat layer and the easy-bonding layer, measured by a crosscut method of JIS-K5600-5-6, are 100%, and residual rates of the hard coat layer and the easy-bonding layer, after ultraviolet radiation (a light resistance test) for 100 hours in an environment at a temperature of 63° C., at a relative humidity of 50%, and with irradiance of 500 W/m², are 100%.

### TECHNICAL FIELD

The present invention relates to a hard coat film to be used for optical members. In more detail, it relates to a hard coat film that can be used as a protective film for a panel display such as an organic electroluminescence (EL) display device, a liquid crystal display (LCD) device, and a plasma display device, display device components such as a touch panel, and the like.

### BACKGROUND ART

For example, it is required to provide scratch resistance to a display surface of a display such as an organic electroluminescence (EL) display device, and a liquid crystal display (LCD) device such that the visibility may not be degraded due to being damaged during handling. Accordingly, it is common to provide a display surface of a display with scratch resistance by using a hard coat film including a hard coat layer on a base material film.

In recent years, with thinning and lightening of a display, thinning of a component member has been progressing. For example, a hard coat film used for a polarizing plate of the display also is also thinned. When the hard coat film is thinned, the dimension stability of the polarizing plate is reduced, and a problem that the polarizing plate warps (curls) under high temperature or high humidity drying occurs.

Thus, as a method for solving the above problems, a cycloolefin polymer film having low moisture absorption (low moisture permeability) and excellent dimensional stability is used as a base material film of the hard coat film.

However, there has a problem that since the cycloolefin polymer film has a smaller number of polar groups (non-polar) on the film surface unlike an acrylic film or a polyester film, when the cycloolefin polymer film is used as a base material, an ultraviolet curable coating material for a hard coat, such as a conventional acrylic resin, does not adhere to it.

In order to improve adhesion between the cycloolefin polymer film and the hard coat layer, generally known methods include a method of obtaining adhesion by surface modification (hydrophilization) of the cycloolefin polymer film by corona treatment, plasma treatment, and the like, prior to hard coat coating, a method of obtaining adhesion by forming a compatible layer on the interface between the hard coat layer and the cycloolefin polymer film base material using a hydrocarbon-based solvent such as toluene for dissolving the cycloolefin polymer film, and a method of providing an anchor layer on a cycloolefin polymer film (for example, Patent Literature 1).

### CITATION LIST

### Patent Literature

Patent Literature 1: Japanese Patent Application Publication No. 2006-110875

### SUMMARY OF INVENTION

### Technical Problem

However, there have been problems that adhesion of a cycloolefin polymer film by the surface modification (hydrophilization) method is lacking in stability, and even if 100% initial adhesion can be secured, an adhesion defect easily occurs particularly over time, and durable adhesion cannot be obtained.

The method of forming the compatible layer has a problem that chemical cracks are generated in the cycloolefin polymer film base material due to solvent erosion into a cycloolefin polymer film base material because the cycloolefin polymer film base material is subjected to an excessive load during hard coat coating. In particular, these chemical cracks tend to be generated more frequently as the cycloolefin polymer film base material becomes thinner.

Furthermore, in a method of providing an anchor layer, although it is common to use modified polyolefin resin for an anchor layer, modified polyolefin resin is easily dissolved in hydrocarbon solvents such as toluene. Therefore, hydrocarbon solvents such as toluene cannot be used as a coating material for hard coats to be applied on the anchor layer, and there is a problem in the design of the coating material.

On the other hand, to improve the durability (light resistance) of a light emitting element in organic EL displays, it is necessary to cut ultraviolet rays (UV) on the display surface side. Generally, the standard of ultraviolet ray cutting performance was based on the transmittance in the wavelength of 380 nm, but recently, transmittance in a range from 390 nm to 410 nm has become a standard for the protection of light emitting devices.

Ultraviolet absorbers, dyes, and the like, for adjusting the transmittance in a region ranging from 390 nm to 410 nm are known, but good solvents for them are hydrocarbon solvents such as toluene. In other words, the coating material for a hard coat in which ultraviolet absorbers, dyes, and the like, are blended for adjusting the transmittance in a region ranging from 390 nm to 410 nm or the purpose of improving the durability (light resistance) of the light emitting element of the organic EL display by the hard coat film, it is necessary to use a hydrocarbon solvent such as toluene in the solvent for the coating material for a hard coat in view of the solubility of the material. Therefore, it is difficult to apply the coating material for a hard coat onto the cycloolefin polymer film base material, especially the thin film cycloolefin polymer film base material because there is a concern of occurrence of chemical cracks.

Thus, an object of the present invention is firstly to provide a hard coat film that is excellent in adhesion (initial adhesion and light-resistance adhesion) between an easy-bonding layer and a hard coat layer provided on the base material film using a cycloolefin polymer-based film as the base material, secondly to provide a hard coat film which has good solvent resistance to the hydrocarbon solvent of the easy-bonding layer provided on the base material film and which can obtain a good coating appearance even when a coating material for a hard coat containing a hydrocarbon solvent is directly applied on the easily adhesive layer, and thirdly to provide a hard coat film which, when used as a protective film on the surface of an organic EL display, can improve the durability (light resistance) of a light emitting element of the organic EL display without adversely affecting the color and luminance of the display of the organic EL display, and can suppress deterioration of the display of the organic EL display.

### Solution to Problem

The present inventors have earnestly studied to solve the above-mentioned problems, and found that above-mentioned problems can be solved by the invention having the following configurations.

In other words, the present invention has the following configuration.

### First Invention

A hard coat film including a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles, and the hard coat film satisfying the following conditions (A) to (D):
(A) a thickness of the easy-bonding layer is in a range from 0.1 μm to 2.0 μm;
(B) a thickness of the hard coat layer is in a range from 1.0 μm to 10.0 μm;
(C) residual rates of the hard coat layer and the easy-bonding layer in the hard coat film, measured by a crosscut method according to JIS-K5600 May 6, are both 100%; and
(D) residual rates of the hard coat layer and the easy-bonding layer, measured by a crosscut method according to JIS-K5600 May 6, after the hard coat film is subjected to ultraviolet radiation (a light resistance test) for 100 hours in an environment at a temperature of 63° C., at a relative humidity of 50%, and with irradiance of 500 W/m², are both 100%.

### Second Invention

The hard coat film according to the first invention, wherein the hard coat film further satisfies the following condition (E), and a light reduction rate (%) at each wavelength, calculated from the following formula 1, satisfies the following conditions (F) to (P):
(E) a b* value is 7.0 or less,

Light reduction rate (%) at each wavelength=(Transmittance of the cycloolefin polymer-based film alone at the wavelength−Transmittance of the hard coat film at the wavelength)/Transmittance of the cycloolefin polymer-based film alone at the wavelength Formula 1)
(F) a light reduction rate at a wavelength of 350 nm is 95.0% or more,
(G) a light reduction rate at a wavelength of 360 nm is 95.0% or more,
(H) a light reduction rate at a wavelength of 370 nm is 95.0% or more,
(I) a light reduction rate at a wavelength of 380 nm is 95.0% or more,
(J) a light reduction rate at a wavelength of 390 nm is 95.0% or more,
(K) a light reduction rate at a wavelength of 400 nm is 95.0% or more,
(L) a light reduction rate at a wavelength of 410 nm is 95.0% or more,
(M) a light reduction rate at a wavelength of 420 nm is 75.0% or less,
(N) a light reduction rate at a wavelength of 430 nm is 30.0% or less,
(O) a light reduction rate at a wavelength of 440 nm is 7.0% or less, and
(P) a light reduction rate at a wavelength of 450 nm is 2.0% or less.

### Third Invention

The hard coat film according to the first invention or the second invention, wherein after the hard coat film is subjected to ultraviolet radiation (a light resistance test) for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):

Change rate (Δ%) of light transmittance at each wavelength=Transmittance of the hard coat film at the wavelength after light resistance test−Transmittance of the hard coat film at the wavelength before light resistance test Formula 2)
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

### Fourth Invention

The hard coat film according to any one of the first to third inventions, wherein a maximum absorption wavelength (Amax) of the ultraviolet absorbing agent is in a range from 350 nm to 380 nm, and a maximum absorption wavelength (Amax) of the dye is in a range from 395 nm to 415 nm.

### Fifth Invention

The hard coat film according to any one of the first to fourth inventions, wherein as the ultraviolet absorbing agent, a benzotriazole-based ultraviolet absorbing agent and a hydroxyphenyl triazine-based ultraviolet absorbing agent are used in combination.

### Sixth Invention

The hard coat film described in any one of the first to fifth inventions, wherein the dye is a cyanine dye.

### Seventh Invention

A hard coat film including a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles, the hard coat film satisfying the following condition (E), and a light reduction rate (%) of each wavelength calculated by the following Formula 1 satisfies the following conditions (F) to (P):

(E) a b* value is 7.0 or less,

Light reduction rate (%) at each wavelength=(Transmittance of the cycloolefin polymer-based film alone at the wavelength−Transmittance of the hard coat film at the wavelength)/Transmittance of the cycloolefin polymer-based film alone at the wavelength; Formula 1)
(F) a light reduction rate at a wavelength of 350 nm is 95.0% or more,
(G) a light reduction rate at a wavelength of 360 nm is 95.0% or more,
(H) a light reduction rate at a wavelength of 370 nm is 95.0% or more,
(I) a light reduction rate at a wavelength of 380 nm is 95.0% or more,
(J) a light reduction rate at a wavelength of 390 nm is 95.0% or more,
(K) a light reduction rate at a wavelength of 400 nm is 95.0% or more,
(L) a light reduction rate at a wavelength of 410 nm is 95.0% or more,
(M) a light reduction rate at a wavelength of 420 nm is 75.0% or less,
(N) a light reduction rate at a wavelength of 430 nm is 30.0% or less,
(O) a light reduction rate at a wavelength of 440 nm is 7.0% or less, and
(P) a light reduction rate at a wavelength of 450 nm is 2.0% or less.

### Eighth Invention

The hard coat film according to the seventh invention, wherein after the hard coat film is subjected to ultraviolet radiation (a light resistance test) for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):

Formula 2) Change rate (Δ%) of light transmittance at each wavelength=Transmittance of the hard coat film at the wavelength after light resistance test-Transmittance of the hard coat film at the wavelength before light resistance test
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

### Ninth Invention

The hard coat film according to the seventh invention or the eighth invention, wherein a maximum absorption wavelength (Amax) of the ultraviolet absorbing agent is in a range from 350 nm to 380 nm, and a maximum absorption wavelength (Amax) of the dye is in a range from 395 nm to 415 nm.

### Tenth Invention

The hard coat film according to any one of the seventh to ninth inventions, wherein as the ultraviolet absorbing agent, a benzotriazole-based ultraviolet absorbing agent and a hydroxyphenyl triazine-based ultraviolet absorbing agent are used in combination.

### Eleventh Invention

The hard coat film described in any one of the seventh to tenth inventions, wherein the dye is a cyanine dye.

### Twelfth Invention

A hard coat film comprising: a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles wherein after the hard coat film is subjected to ultraviolet radiation (a light resistance test) for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):

Change rate (Δ%) of light transmittance at each wavelength=Transmittance of the hard coat film at the wavelength after light resistance test−Transmittance of the hard coat film at the wavelength before light resistance test Formula 2)
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

### Thirteenth Invention

The hard coat film according to the twelfth invention, wherein a maximum absorption wavelength (Amax) of the ultraviolet absorbing agent is in a range from 350 nm to 380 nm, and a maximum absorption wavelength (Amax) of the dye is in a range from 395 nm to 415 nm.

### Fourteenth Invention

The hard coat film according to the twelfth invention or the thirteenth invention, wherein as the ultraviolet absorbing agent, a benzotriazole-based ultraviolet absorbing agent and a hydroxyphenyl triazine-based ultraviolet absorbing agent are used in combination.

### Fifteenth Invention

The hard coat film described in any one of the twelfth to fourteenth inventions, wherein the dye is a cyanine dye.

### Advantageous Effects of Invention

The present invention can provide a hard coat film in which a cycloolefin polymer-based film is used as a base material, a hard coat film excellent in adhesion (initial adhesion and light resistance adhesion) between an easily adhesive layer and a hard coat layer provided on the base material film, even to such a base material having few polar groups and poor adhesion.

Furthermore, the present invention can provide a hard coat film which has excellent solvent resistance to a hydrocarbon solvent in the easy-bonding layer provided on the base material film, and which can obtain an excellent coating appearance even when a coating material containing a hydrocarbon solvent for a hard coat is directly applied to the easy-bonding layer.

Furthermore, the present invention can provide a hard coat film in which when used as a protective film on the surface of an organic EL display, the durability (light resistance) of a light emitting element of the organic EL display can be improved and deterioration of the display of the organic EL display can be suppressed without adversely affecting the color and luminance of the display of the organic EL display.

In particular, when a thin cycloolefin polymer-based film is used as the base material, the hard coat film of the present invention is suitable.

### DESCRIPTION OF EMBODIMENTS

Hereinafter, embodiments for carrying out the present invention will be described in detail, but the present invention is not limited to the following embodiments.

Note here that in the present specification, unless especially stated otherwise, “from xx to yy” means “xx or more and yy or less”.

As described in the first invention, the hard coat film of the present invention includes a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles, the hard coat film satisfying the following conditions (A) to (D):
(A) a thickness of the easy-bonding layer is in a range from 0.1 μm to 2.0 μm;
(B) a thickness of the hard coat layer is in a range from 1.0 μm to 10.0 μm;
(C) residual rates of the hard coat layer and the easy-bonding layer in the hard coat film, measured by a crosscut method according to JIS-K5600 May 6, are both 100%; and
(D) residual rates of the hard coat layer and the easy-bonding layer, measured by a crosscut method according to JIS-K5600 May 6, after the hard coat film is subjected to ultraviolet radiation (a light resistance test) for 100 hours in an environment at a temperature of 63° C., at a relative humidity of 50%, and with irradiance of 500 W/m², are both 100%.

Hereinafter, a configuration of the hard coat film will be described in detail.

### [Base Material Film]

Firstly, a base material film of the hard coat film will be described.

In the present invention, as the base material film of the hard coat film, a cycloolefin polymer-based film excellent in transparency, heat resistance, dimensional stability, low moisture absorption (low moisture permeability), low birefringence, optical isotropy, and the like, is used. Specifically, cycloolefin copolymer films or cycloolefin polymer films, which are copolymers in which cycloolefin units are alternately or randomly polymerized in a polymer backbone and have an alicyclic structure in a molecular structure, and which contain at least one compound selected from a norbornene compound, a monocyclic cyclic olefin, a cyclic conjugated diene, and a vinyl alicyclic hydrocarbon, can be appropriately selected and used.

Furthermore, in the present invention, a thickness of the cycloolefin polymer-based film is appropriately selected according to applications, but from the viewpoint of demand for thinning of a hard coat film in accordance with reduction in thickness and light of a display, the thickness is preferably 50 μm or less, and particularly preferably 30 μm or less. On the other hand, from the viewpoint of mechanical strength, handling property, and the like, the thickness is preferably 10 μm or more.

In the present invention, when a hard coat layer is formed on one side of the cycloolefin polymer-based film via an easy-bonding layer, on the back side of the cycloolefin polymer-based film on which the hard coat layer is not formed, for the purpose of preventing bonding of the cycloolefin polymer-based film winding and improving the runnability of the film when forming the cycloolefin polymer-based film, a film may be obtained by stacking a polyethylene resin, a polypropylene resin, or a polyester resin having excellent mold release property from the cycloolefin polymer-based film by a coextrusion method may be laminated as a protective layer. Furthermore, a protective film such as polyethylene resin, polypropylene resin, or polyester resin having a weakly adhesive layer formed on the back surface can also be used.

Examples of the cycloolefin polymer-based film include commercially available products such as ZEONOR (trade name, manufactured by Zeon Corporation), Optica (trade name: manufactured by Mitsui Chemicals Co., Ltd.), Arton (trade name: manufactured by JSR Co., Ltd.), Kozek (trade name: manufactured by Kurashiki Spinning Co., Ltd.), and the like.

### [Easy-Bonding Layer]

Next, easy-bonding layer of the hard coat film is described.

In the hard coat film of the present invention, the easy-bonding layer is made of an ultraviolet curable resin containing inorganic fine particles.

In the present invention, the resin used for the easy-bonding layer is not particularly limited as long as resin is an ultraviolet curable resin, and is transparent and cured by irradiation with ultraviolet rays (hereinafter, abbreviated as “UV”), but, for example, an acrylic resin having a basic skeleton made of a polymer of an acrylic ester or a methacrylic ester, a urethane acrylate resin including a urethane bond formed by reacting an isocyanate group with a hydroxy group and an acrylic group, or the like, can be preferably used. In order for the easy-bonding layer to form a three-dimensional cross-linked structure, it is preferable that the easy-bonding layer is made of a UV-curable polyfunctional acrylate having, for example, a plurality of functional groups such as (meth)acryloyloxy groups in the molecule. Specific examples of the UV-curable polyfunctional acrylates having a plurality of (meth)acryloyloxy groups in one molecule include trimethylol propane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, trimethylolpropane ethoxytriacrylate, glycerin propoxy triacrylate, ditrimethylolpropane tetracrylate, and the like. Herein, the polyfunctional groups may be used alone or in a combination of plurality of two or more kinds.

By using an ultraviolet curable resin as a binder resin of the easy-bonding layer, a solvent other than a hydrocarbon solvent can be used as a coating liquid for forming the easy-bonding layer (hereinafter also referred to as “coating material for an easy-bonding layer”). Therefore, even if the coating material for the easy adhesive layer is applied to the cycloolefin polymer-based film base material having low solvent resistance to a hydrocarbon solvent such as toluene, the occurrence of chemical cracks in the cycloolefin polymer film base material can be prevented. Furthermore, by using an ultraviolet curable resin as the binder resin of the easy-bonding layer, the cured easy-bonding layer has good solvent resistance to a hydrocarbon solvent such as toluene, and therefore, a hydrocarbon solvent such as toluene can be used as the solvent of the coating liquid for forming the hard coat layer (hereinafter also referred to as “coating material for a hard coat”) to be applied on the easy-bonding layer, which is advantageous in terms of the design of coating material for a hard coat.

Furthermore, the ultraviolet curable resins used in the easy-bonding layer mentioned above is preferably a monomer or an oligomer or a polymer having a weight-average molecular weight in the range of from 500 to 3600, more preferably the weight-average molecular weight in the range of from 500 to 3000, and further more preferably the weight-average molecular weight in the range of from 500 to 2400. When the weight-average molecular weight is less than 500, a curing contraction when cured by UV irradiation is large, a phenomenon (curl) in which the hard coat film warps toward the hard coat layer surface side becomes large, and failure occurs during the subsequent processing process, and the processing suitability becomes poor. Furthermore, the weight-average molecular weight of more than 3600 is not suitable because the hardness of the easy-bonding layer becomes insufficient and the solvent resistance of the easy-bonding layer to hydrocarbon solvents is difficult to be obtained.

Furthermore, resins included in the easy-bonding layer may include a thermoplastic resin such as polyethylene, polypropylene, polystyrene, polycarbonate, polyester, acrylic resin, styrene-acrylic, or fibrin, or a thermosetting resin such as a phenolic resin, a urea resin, unsaturated polyester, epoxy, or a silicon resin, in addition to the ultraviolet curable resin mentioned above, within a range that does not damage the effect of the present invention.

In the present invention, the easy-bonding layer contains inorganic fine particles. When the easy-bonding layer contains inorganic fine particles, the adhesion (the initial adhesion and the light-resistance adhesion) between the cycloolefin polymer-based film base material and the easy-bonding layer can be improved, and the adhesion (the initial adhesion and the light-resistance adhesion) between the easy-bonding layer and the hard coat layer can be improved. When the easy-bonding layer contains inorganic fine particles, surface unevenness are formed in the easy-bonding layer, the contact interface between the base material film and the hard coat layer becomes large (increase in the surface area of the easy-bonding layer), and the hard coat layer enters into the surface unevenness of the easy-bonding layer, solidifies, and acts like a wedge (anchoring force), resulting in an effect of improving adhesion. In other words, the surface unevenness state of the top layer of the easy-bonding layer can be adjusted to an optimum range of adhesion between the base material film and the hard coat layer.

Examples of inorganic fine particles include fine particles such as silica, alumina, zinc oxide, titanium oxide, cerium oxide, and the like. As the particle diameter, for example, fine particles having an average particle diameter of 5 nm to 300 nm are preferably used. When an average particle diameter is less than 5 nm, the effect of improving the adhesion mentioned above cannot sufficiently obtained. On the other hand, when the average particle diameter is more than 300 nm, transparency of the easy-bonding layer may be deteriorated.

In the present invention, the blending amount of the inorganic fine particles is preferably 5 to 40 parts by mass with respect to 100 parts by mass of the ultraviolet curable resin of the easy-bonding layer. When the blending amount of the inorganic fine particles is less than 5 parts by mass, the improvement of the adhesion mentioned above cannot be sufficiently obtained. On the other hand, when the blending amount is more than 40 parts by mass, the transparency of the easy-bonding layer is reduced.

Coating materials for easy-bonding layers for forming the easy-bonding layer include a photopolymerization initiator. As such a photopolymerization initiator, acetophenones such as commercially available IRGACURE 651 and IRGACURE 184 (both manufactured by BASF) and benzophenones such as IRGACURE 500 (manufactured by BASF) can be used.

Furthermore, a leveling agent can be blended into the easy-bonding layer to adjust the surface characteristics (surface free energy, water contact angle, and the like) and improve coatability. For example, well-known levelling agents such as a fluorine based leveling agent, an acryl based leveling agent, a siloxane based leveling agent and adducts thereof or mixtures thereof may be used. The blending amount is appropriately determined in accordance with, for example, adjustment of surface properties and coatability.

Furthermore, as another additive to be added to the easy-bonding layer, in the range that does not damage the effect of the present invention, a defoaming agent, an antifouling agent, an antioxidant, an antistatic agent, or a light stabilizer may be added as necessary.

The thickness (coating film thickness) of the easy-bonding layer in the present invention is suitably in the range from 0.1 μm to 2.0 μm. When the thickness of the easy-bonding layer is less than 0.1 μm, the effect of improving the adhesion described above cannot be sufficiently obtained, and it becomes difficult to obtain the solvent resistance of the easy-bonding layer to the hydrocarbon solvent. On the other hand, from the viewpoint of thinning the hard coat film, the thickness of the easy-bonding layer is desirably 2.0 μm or less.

The easy-bonding layer is formed by applying coating material (coating material for the easy-bonding layer) in which the inorganic fine particles, a photopolymerization initiator, a leveling agent, if necessary, other additives, and the like, in addition to the ionizing radiation-curable resin, in a suitable solvent, are dissolved and dispersed in the cycloolefin polymer-based film (base material film), dried, and then cured by irradiation with UV. In this case, the solvent can be appropriately selected depending on the solubility of the resin and the like, and is preferably a solvent that can uniformly dissolve and disperse at least solid part (resin, photopolymerization initiator, other additives, and the like) and, for example, is an organic solvent having a boiling point of 50° C. to 120° C. from the viewpoint of workability during coating and drying property. Examples of such organic solvents include ester-based solvents such as methyl acetate, ethyl acetate, propyl acetate, isopropyl acetate, butyl acetate, and methyl lactate; ketone-based solvents such as acetone, methyl ethyl ketone, methyl isobutyl ketone, and cyclohexanone; and alcohol-based solvents such as methanol, ethanol, isopropyl alcohol, n-propyl alcohol and butanol, which can be used alone or also in an appropriate number of combination types thereof. As described above, when ultraviolet curable resin is used as the binder resin for the easy-bonding layer, a solvent other than hydrocarbon solvent can be used as coating material solvent for the easy-bonding layer. Thus, even if the coating material for the easy-bonding layer is applied onto the base material of the cycloolefin polymer-based film having low solvent resistance to hydrocarbon solvents such as toluene, the occurrence of chemical cracks in the cycloolefin polymer film base material can be prevented.

Examples of the method for applying the coating material for the easy-bonding layer on the base material film include well-known coating methods such as a gravure coating, a micro gravure coating, a fountain-bar coating, a slide die coating, a slot die coating, a screen printing method, a spray coating method, or the like. The coating material coated on the cycloolefin polymer-based film is dried usually at a temperature of about 50° C. to 120° C. while appropriately adjusting the drying conditions (drying furnace temperature, furnace wind speed, drying time, and the like) to remove the solvent and form a coating film.

Furthermore, an irradiation dose of ultraviolet rays (UV) after formation of the easy-bonding layer may be an irradiation dose that allows the easy bonding layer to have appropriate hardness, and can be appropriately set depending on types of ultraviolet curable resins.

As the irradiation dose of ultraviolet rays, the integrated amount of light is preferably set to, for example, 50 to 300 mJ/cm². When the integrated amount of light is less than 50 mJ/cm², the adhesion between the cycloolefin polymer-based film base material and the easy-bonding layer cannot sufficiently be obtained. On the other hand, when the integrated amount of light is more than 300 mJ/cm², deformation of the cycloolefin polymer-based film base material occurs, and appearance may be damaged.

Furthermore, in the present invention, the surface free energy on the easy-bonding layer is preferably 22 mN/m or more.

Herein, the surface free energy described above is defined as the “free energy possessed by a unit area of the surface” and refers to energy excessively possessed by the surface of the easy-bonding layer as compared with that of the inside (bulk) of the layer. As the surface free energy of a solid is larger, gases and particles are adsorbed more easily, and the liquid becomes wet and attached to the other solid more easily.

The surface free energy can be measured by analyzing a contact angle between water and hexadecane by the Kaelble-Uy method using a contact angle meter. Specifically, the surface free energy of the easy-bonding layer is a value obtained by measuring the contact angle at 30 seconds after dropping 1 μL of water (pure water) on the surface of the easy-bonding layer and measuring the contact angle at 30 seconds after dropping 1 μL of n-hexadecane on the surface of the easy adhesion layer using a fully automatic contact angle meter DM-701 manufactured by Kyowa Interface Science Co., Ltd., and calculating by the Kaelble-Uy method using the obtained contact angle of the water and the contact angle of n-hexadecane.

The value of the surface free energy of the easy-bonding layer indicates an index of the adhesion of the hard coat layer to a resin. In the present invention, when the surface free energy is 22 mN/m or more, the intermolecular force between the molecules of the hard coat layer resin and the molecules of the easy-bonding layer increases, thereby contributing to the improvement of the adhesion of the hard coat layer. When the surface free energy is less than 22 mN/m, the adhesion with respect to the hard coat layer is deteriorated, and cissing may occur during coating of the hard coat layer. In the present invention, the surface free energy of the easy-bonding layer is particularly preferably 25 mN/m or more.

Furthermore, also when the surface free energy of the easy-bonding layer is too large, the dirt is likely to stick to the surface, causing contamination of foreign matter or deterioration of scratch resistance. Therefore, the upper limit of the surface free energy is preferably 40 mN/m or less, more preferably 38 mN/m or less, and further more preferably 35 mN/m or less.

Note here that the surface free energy of the easy-bonding layer can be adjusted by, for example, addition of leveling agent to the easy-bonding layer (types, addition amount, or the like, of the leveling agent) and the like.

Furthermore, in the present invention, it is further preferable that a water contact angle of the easy-bonding layer is 90 degrees or less.

The contact angle of water on the surface of the easy-bonding layer is obtained by dropping 1 μL of water (pure water) on the surface of the easy-bonding layer using a fully automatic contact angle meter DM-701 manufactured by Kyowa Interface Science Co., Ltd., and measuring the contact angle after 30 seconds.

The value of the water contact angle on the surface of the easy-bonding layer is an index indicating the adhesion of the resin used for the hard coat layer, in the present invention, since the water contact angle on the surface of the easy adhesion layer is 90 degrees or less, the intermolecular force between the molecules of the hard coat layer resin and the molecules of the easy-bonding layer increases, thereby contributing to the improvement of the adhesion of the hard coat layer. On the other hand, when the contact angle is larger than 90 degrees, the adhesion with respect to the hard coat layer is deteriorated, and cissing may occur during coating of the hard coat layer.

In the present invention, it is particularly preferable that the water contact angle on the surface of the easy-bonding layer is 85 degrees or less.

Note here that it is desirable that when the water contact angle is too low, the scratch resistance of the easy-bonding layer tends to be deteriorated, so that the water contact angle is desirably 50 degrees or more.

Note here that the water contact angle on the surface of the easy-bonding layer can be adjusted by, for example, addition of leveling agent to the easy-bonding layer (types, addition amount, or the like, of the leveling agent) and the like.

### [Hard Coat Layer]

Next, a hard coat layer of the hard coat film will be described.

In the present invention, the hard coat layer contains at least an ultraviolet curable resin, an ultraviolet absorbing agent, and a dye.

In the present invention, as a resin included in the hard coat layer, an ultraviolet curable resin is preferably used, in particular, from the viewpoint of providing surface hardness (pencil hardness, scratch resistance) of the hard coat layer, being capable of adjusting a degree of crosslinking by an exposure amount of ultraviolet ray, and being capable of adjusting the surface hardness of the hard coat layer.

The ultraviolet curable resin to be used for the present invention is not particularly limited as long as it is a transparent resin that is cured by irradiation of ultraviolet light (UV). However, in order for the coated film hardness and the hard coat layer to form a three-dimensional cross-linking structure, ones made of UV-curable polyfunctional acrylate having three or more (meth)acryloyloxy groups in one molecule are preferable. Specific examples of the UV-curable polyfunctional acrylates having three or more (meth)acryloyloxy groups in one molecule include trimethylol propane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, trimethylolpropane ethoxytriacrylate, glycerin propoxy triacrylate, ditrimethylolpropane tetracrylate, and the like. Note here that the polyfunctional groups may be used alone or in a combination of plurality of two or more kinds.

Furthermore, the ultraviolet curable resins used in the hard coat layer is preferably a monomer or an oligomer or a polymer having a weight-average molecular weight in the range of from 500 to 3600, more preferably the weight-average molecular weight in the range of from 500 to 3000, and further more preferably the weight-average molecular weight in the range of from 500 to 2400. When the weight-average molecular weight is less than 500, a curing contraction when cured by UV irradiation is large, a phenomenon (curl) in which the hard coat film warps toward the hard coat layer surface side becomes large, and failure occurs during the subsequent processing process, and the processing suitability becomes poor. Furthermore, the weight-average molecular weight of more than 3600 is not suitable because flexibility of the hard coat layer is enhanced but hardness become insufficient.

Furthermore, when the ultraviolet curable resin used in the hard coat layer has the weight-average molecular weight of less than 1500, the number of the functional groups in one molecule is desirably 3 or more and less than 10. Furthermore, when the ultraviolet curable resin has the weight-average molecular weight of 1500 or more, the number of the functional groups in one molecule is desirably 3 or more and 20 or less. When in the above range, curl may be suppressed, and appropriate processing suitability may be maintained.

Furthermore, as the resin included in the hard coat layer, a thermoplastic resin such as polyethylene, polypropylene, polystyrene, polycarbonate, polyester, acrylic, styrene-acrylic, and fibrin, or a thermosetting resin such as a phenolic resin, a urea resin, unsaturated polyester, epoxy, and a silicon resin, in addition to ultraviolet curable resin, may be blended within a range that does not damage the hardness or the scratch resistance of the hard coat layer.

In the present invention, the hard coat layer contains an ultraviolet absorbing agent and a dye in addition to the ultraviolet curable resin.

As the ultraviolet absorbing agent used in the present invention, an ultraviolet absorbing agent with a maximum absorption wavelength (Amax) ranging from 350 nm to 380 nm is suitable.

In the present invention, for example, a benzotriazole-based ultraviolet absorbing agent, a hydroxyphenyl triazine-based ultraviolet absorbing agent, and the like, can be preferably used. It is particularly preferable that the benzotriazole-based ultraviolet absorbing agent and the hydroxyphenyl triazine-based ultraviolet absorbing agent are used in combination.

Furthermore, as the dye used in the present invention, it is particularly preferable that the dye having a maximum absorption wavelength (Amax) ranging from 395 nm to 415 nm.

In the present invention, for example, the dye is preferably a cyanine dye.

The hard coat film of the present invention includes the hard coat layer containing the ultraviolet absorber and the dye mentioned above, so that the spectral characteristics (light reduction rate and the change rate of light transmittance after light resistance test at each wavelength from 350 nm to 450 nm) can satisfy the scope of the present invention.

In the present invention, the blending amount of the ultraviolet absorbing agent is preferably 1 to 30 parts by mass with respect to 100 parts by mass of the ultraviolet curable resin of the hard coat layer. When the blending amount of the ultraviolet absorbing agent is less than 1 part by mass, the spectral characteristics of the present invention cannot be sufficiently satisfied. On the other hand, when the blending amount is more than 30 parts by mass, it is difficult for the b* value serving as an indicator of yellowness to satisfy the scope of the present invention and the hardness and adhesion of the hard coat layer are insufficient.

Furthermore, the blending amount of the dye is preferably 0.1 to 10 parts by mass with respect to 100 parts by mass of the ultraviolet curable resin of the hard coat layer. When the blending amount of the dye is less than 0.1 parts by mass, the spectral characteristics of the present invention cannot be sufficiently satisfied. On the other hand, when the blending amount is more than 10 parts by mass, it is difficult for the b* value serving as an indicator of yellowness to satisfy the scope of the present invention and the hardness and adhesion of the hard coat layer are insufficient.

Furthermore, it is also possible to further improve the surface hardness (scratch resistance) by allowing the hard coat layer to contain inorganic oxide fine particles. In this case, an average particle diameter of the inorganic oxide fine particles is preferably in the range of from 5 to 50 nm, and the average particle diameter is more preferably in the range of from 10 to 40 nm. When the average particle diameter is less than 5 nm, it is difficult to obtain sufficient surface hardness. On the other hand, when the average particle diameter is more than 50 nm, gloss and transparency of the hard coat layer easily degrade, and the flexibility may also degrade.

In the present invention, examples of the inorganic oxide fine particles may include alumina and silica. Among these, the alumina is particularly suitable because alumina mainly made of aluminum has high hardness and may exhibit an effect at a smaller addition amount than silica.

In the present invention, a content of the inorganic oxide fine particles is preferably from 0.1 to 10.0 parts by mass relative to 100 parts by mass of the ultraviolet curable resin of the hard coat layer. When the content of the inorganic oxide fine particles is less than 0.1 parts by mass, it is difficult to obtain an effect of improving the surface hardness (scratch resistance). On the other hand, the content of more than 10.0 parts by mass is not preferable because haze increases.

The coating material for a hard coat for forming the hard coat layer can include a photopolymerization initiator. Examples of such a photopolymerization initiator include acetophenones such as commercially available IRGACURE 651 and IRGACURE 184 (both are trade name, manufactured by BASF), and benzophenones such as IRGACURE 500 (trade name, manufactured by BASF).

For the hard coat layer, a levelling agent may be used to improve the coating property. For example, well-known levelling agents such as a fluorine based leveling agent, an acryl based leveling agent, a siloxane based leveling agent and adducts thereof or mixtures thereof may be used. As a blending amount, the levelling agent may be blended in the range from 0.03 to 3.0 parts by mass relative to 100 parts by mass of the solid content of resin of the hard coat layer. Furthermore, in applications to touch panels or the like, in the case where an anti-bonding property using an optically transparent adhesive agent OCR is required for the purpose of bonding with a cover glass (CG), a transparent conductive member (TSP), a liquid crystal module (LCM), or the like, of a touch panel terminal, an acrylic-based levelling agent or a fluorine-based levelling agent having high surface free energy (about 30 mN/m or more) is preferably used.

As the other additives to be added to the hard coat layer, a defoaming agent, a surface tension controlling agent, an antifouling agent, an antioxidant, an antistatic agent, a light stabilizer, or the like, may be added, if necessary, in the range that does not damage the effect of the present invention.

The hard coat layer is formed by dissolving, in addition to the ultraviolet curable resin described above the ultraviolet absorber, dye, photopolymerization initiator, other additive, or the like, in a suitable solvent and dispersing the hard coat coating material, on the easy adhesive layer, drying it, and then curing it by irradiation with UV. As the solvent, any solvent can be appropriately selected according to the solubility of a resin to be blended and may be a solvent capable of uniformly dissolving or dispersing at least the solid content (resin, an ultraviolet absorbing agent, dye, polymerization initiator, and other additives). As such a solvent, well-known organic solvents can be used. Examples of the organic solvents include aromatic-based solvents such as toluene, xylene, and n-heptane; aliphatic-based solvents such as cyclohexane, methyl cyclohexane, and ethyl cyclohexane; ester-based solvents such as methyl acetate, ethyl acetate, propyl acetate, isopropyl acetate, butyl acetate, and methyl lactate; ketone-based solvents such as acetone, methyl ethyl ketone, methyl isobutyl ketone, and cyclohexanone; and alcohol-based solvents such as methanol, ethanol, isopropyl alcohol, and n-propyl alcohol, which can be used alone or also in an appropriate number of combination types.

According to the present invention, since the solvent resistance with respect to the hydrocarbon solvent of the easy-bonding layer is good, even if a coating material such as toluene for hard coat containing a hydrocarbon solvent is directly applied on the easy-bonding layer, excellent coating appearance can be obtained.

The coating method of the coating material for a hard coat for forming the hard coat layer is not particularly limited. A well-known coating method such as a gravure coating, a micro gravure coating, a fountain-bar coating, a slide die coating, a slot die coating, a screen printing method, or a spray coating method may be used for coating, followed by drying usually at a temperature of from about 50 to 120° C.

The irradiation dose of ultraviolet rays (UV) after the formation of coating film of the hard coat layer may be an irradiation dose necessary to provide hardness of the hard coat layer, and can be appropriately set according to the types of the ultraviolet curable resin.

In the present invention, a thickness (coating thickness) of the hard coat layer is, for example, preferably in a range from 1.0 μm to 10.0 μm, and further preferably in a range from 1.5 μm to 5.0 μm. It is not preferable that the coating thickness is less than 1.0 μm, because necessary surface hardness (for example, scratch resistance) is deteriorated. Furthermore, the coating thickness is more than 10.0 μm is not preferable from the viewpoint of thinning the hard coat film, and because curl occurs strongly to result in degradation of handling property in the manufacturing process or the like.

As described above, the hard coat film of the present invention includes a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles.

Then, the hard coat film of the present invention satisfies the following conditions (A) to (D).
(A) a thickness of the easy-bonding layer is in a range from 0.1 μm to 2.0 μm;
(B) a thickness of the hard coat layer is in a range from 1.0 μm to 10.0 μm;
(C) residual rates of the hard coat layer and the easy-bonding layer in the hard coat film, measured by a crosscut method according to JIS-K5600 May 6, are both 100%; and
(D) residual rates of the hard coat layer and the easy-bonding layer, measured by a crosscut method according to JIS-K5600 May 6, after the hard coat film is subjected to ultraviolet radiation (a light resistance test) for 100 hours in an environment at a temperature of 63° C., at a relative humidity of 50%, and with irradiance of 500 W/m², are both 100%.

The conditions (A) and (B) are the same as mentioned above.

Furthermore, the hard coat film of the present invention satisfies the above conditions (C) and (D). Thus, it is possible to obtain a hard coat film in which a cycloolefin polymer-based film is used as a base material, a hard coat film excellent in adhesion (initial adhesion and light resistance adhesion) between an easy-bonding layer and a hard coat layer provided on the base material film, even to such a base material having few polar groups and poor adhesion. Note here that more detail of the adhesion test by a crosscut method according to JIS-K5600 May 6, and the light resistance test will be described in Examples mentioned below.

Furthermore, the hard coat film of the present invention includes a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles, and the hard coat film satisfying the following condition (E), and a light reduction rate (%) at each wavelength satisfies the following conditions (F) to (P):
(E) a b* value is 7.0 or less,
(F) a light reduction rate at a wavelength of 350 nm is 95.0% or more,
(G) a light reduction rate at a wavelength of 360 nm is 95.0% or more,
(H) a light reduction rate at a wavelength of 370 nm is 95.0% or more,
(I) a light reduction rate at a wavelength of 380 nm is 95.0% or more,
(J) a light reduction rate at a wavelength of 390 nm is 95.0% or more,
(K) a light reduction rate at a wavelength of 400 nm is 95.0% or more,
(L) a light reduction rate at a wavelength of 410 nm is 95.0% or more,
(M) a light reduction rate at a wavelength of 420 nm is 75.0% or less,
(N) a light reduction rate at a wavelength of 430 nm is 30.0% or less,
(O) a light reduction rate at a wavelength of 440 nm is 7.0% or less, and
(P) a light reduction rate at a wavelength of 450 nm is 2.0% or less.

Herein, the light reduction rate in each wavelength is calculated by the following formula 1.

Light reduction rate (%) at each wavelength=(Transmittance of the cycloolefin polymer-based film alone at the wavelength−Transmittance of the hard coat film at the wavelength)/Transmittance of the cycloolefin polymer-based film alone at the wavelength Formula 1)

Furthermore, the b* value defined by the above condition (E) serves as an indicator of yellowness, and shows that the larger the numerical value is, the stronger the yellowness property is.

Note here that specific measurement method of light transmittance of the above b* value in each wavelength described in the description of Examples mentioned below.

The hard coat film of the present invention includes a hard coat layer including an ultraviolet curable resin containing the ultraviolet absorbing agent and the dye, and satisfies the optical property of the present invention, that is, the above-mentioned conditions (E) to (P). Thus, the hard coat film of the present invention suppresses the b* value serving as an indicator of yellowness, does not cause an adverse effect on the color of a display of an organic EL display, and can suppress damages such as deterioration of some polymers or damage such as fading and discoloration of a dye because the light reduction rate at a wavelength of 350 nm to 400 nm, causing deterioration of some polymers or damage such as fading and discoloration of dye, is 95% or more. Furthermore, in recent years, for the purpose of improving durability (light resistance) of a light emitting element of the organic EL display, it has been required to sufficiently reduce the light transmittance at 390 nm to 410 nm to protect the light emitting element. Since the hard coat film of the present invention has a light reduction rate at a wavelength of 390 nm to 410 nm of 95% or more, the durability (light resistance) of the light emitting element of the organic EL display of recent years can be improved. On the other hand, the wavelength of 420 nm to 450 nm in the visible light range is required to have a reduced light reduction rate as much as possible to secure the brightness of the display of the organic EL display. The hard coat film of the present invention can suppress the light reduction rate of the wavelength of 420 nm to 450 nm, and does not adversely affect the brightness of the display of the organic EL display.

Furthermore, the hard coat film of the present invention includes a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles, wherein after the hard coat film is subjected to ultraviolet radiation (a light resistance test) for 100 hours in an environment at a temperature of 63° C., at a relative humidity of 50%, and with irradiance of 500 W/m², an absolute value of a change rate (Δ%) of light transmittance at each wavelength satisfies the following conditions (Q) to (AA):
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

Herein, the change rate (Δ%) of light transmittance at each wavelength is calculated by the following formula 2.

Change rate (Δ%) of light transmittance at each wavelength=Transmittance of the hard coat film at the wavelength after light resistance test−Transmittance of the hard coat film at the wavelength before light resistance test Formula 2)

The hard coat film of the present invention includes a hard coat layer including ultraviolet curable resin containing the ultraviolet absorbing agent and the dye, and satisfies the optical property of the present invention, that is, the above-mentioned conditions (Q) to (AA) even after the light resistance test.

The transmittance at each wavelength, from the purpose thereof, is required to be maintained also after light resistance test, at a wavelength of 350 nm to 400 nm, causing deterioration of some polymers or damage such as fading and discoloration of dye, and at a wavelength of 390 nm to 410 nm contributing to protection of the light emitting element of the recent organic EL display. Since the durability and the hard coat film of the present invention can suppress the change rate of the light transmittance at a wavelength of 350 nm to 400 nm and at a wavelength of 390 nm to 410 nm, deterioration of the display of the organic EL display can be suppressed. Furthermore, also at a wavelength of 420 nm to 450 nm in the visible light range, the performance is required to be maintained also after light resistance test, but the hard coat film of the present invention can suppress the change rate of the light transmittance, and maintain the brightness of the display of the organic EL display.

As described above in detail, according to the present invention, a hard coat film can be obtained in which a cycloolefin polymer-based film is used as a base material, a hard coat film excellent in adhesion (initial adhesion and light resistance adhesion) between an easy-bonding layer and a hard coat layer provided on the base material film, even to such a base material having few polar groups and poor adhesion. Furthermore, the present invention can provide a hard coat film which has excellent solvent resistance to a hydrocarbon solvent in the easy-bonding layer provided on the base material film, and which can obtain an excellent coating appearance even when a coating material containing a hydrocarbon solvent for a hard coat is directly applied to the easy-bonding layer. Furthermore, the present invention can provide a hard coat film in which when used as a protective film on the surface of an organic EL display, the durability (light resistance) of a light emitting element of the organic EL display can be improved and deterioration of the display of the organic EL display can be suppressed without adversely affecting the color and luminance of the display of the organic EL display. In particular, when a thin cycloolefin polymer-based film is used as the base material, the hard coat film of the present invention is suitable.

### EXAMPLE

Next, embodiments of the present invention will be specifically described in more detail with reference to Examples, but the present invention is not limited to the following Examples.

Note here that unless otherwise particularly noted, “part” described below represents “part by mass”, and “%” described below represents “% by mass”.

### Example 1

### [Preparation of Coating Liquid for Forming Easy-Bonding Layer]

A coating liquid for forming an easy-bonding layer having solid content concentration of 10% (hereinafter, referred to as “coating material for an easy-bonding layer”) was prepared by diluting 100 parts of acrylate-based ultraviolet curable resin coating material (Luxidia CH-C-1623 (trade name), manufactured by DIC Co., Ltd.) containing silica fine particles (average particle diameter: 100 nm) of the present invention with methyl ethyl ketone/1-methoxy-2-propanol=50/50 (parts by weight).

### [Preparation of Coating Liquid for Forming Hard Coat Layer]

A coating liquid for forming a hard coat layer having a final solid content concentration of 30% (hereinafter, referred to as a “coating material for a hard coat”) was prepared by blending 85 parts of acrylate-based ultraviolet curable resin coating material containing a benzotriazole-based ultraviolet absorbing agent of the present invention (HFC-UVA-1 (trade name); manufactured by Halima Kasei Co., Ltd. Maximum absorption wavelength of the benzotriazole-based ultraviolet absorbing agent: 370 nm) as a main material, 3.5 parts of IRGACURE 184 (photopolymerization initiator, manufactured by BASF), 0.5 parts of surface modifier (Ftergent 681; manufactured by NEOS Company Limited), and 10 parts of a hydroxyphenyl triazine-based ultraviolet absorbing agent of the present invention (Tinuvin 477 (trade name); manufactured by BASF, maximum absorption wavelength: 356 nm), and 1.0 part of cyanine dye of the present invention (NK-9994 (trade name); manufactured by Hayashibara Co., Ltd., maximum absorption wavelength; 405 nm), and diluting with toluene/methyl ethyl ketone/propylene glycol monomethyl ether acetate=15/35/50 (parts by weight).

### [Production of Hard Coat Film]

On one surface of ZEONOR film ZD12 (manufactured by Zeon Corporation) having a thickness of 26 μm as the cycloolefin film, the coating material for an easy-bonding layer was applied using a bar coater and dried and solidified by hot air drying for 1 minute using a drying furnace at 60° C. to form an easy-bonding layer coating film having a coating thickness of 0.2 μm. The obtained film was cured by UV irradiation with a UV irradiation amount of 50 mJ/cm² using a UV irradiation device set at a height of 60 mm from the coating surface to form an easy-bonding layer, and thus, an easy-bonding layer coated film was obtained.

Next, on the easy-bonding layer of the easy-bonding layer coated film, the hard coat layer coating material was coated using a bar coater and hot air dried for 1 minute in a drying furnace at 80° C., thus a coated layer having a coated film thickness: 4.5 μm was formed. This was cured at a UV irradiation amount of 100 mJ/cm² using a UV irradiation device set at a height of 60 mm from a coated surface to produce a hard coat film of Example 1.

### Example 2

A hard coat film of Example 2 was produced in the same manner as in Example 1 except that the cycloolefin polymer film of Example 1 was changed to ZEONOR film ZF16 (manufactured by Zeon Corporation) having a thickness of 50 μm.

### Example 3

A hard coat film of Example 3 was produced in the same manner as in Example 1 except that the cycloolefin polymer film of Example 1 was changed to ZEONOR film ZF12 (manufactured by Zeon Corporation) having a thickness of 13 μm.

### Example 4

### [Preparation of Coating Material for Easy-Bonding Layer]

A coating material for an easy-bonding layer having solid content concentration of 10% was prepared by diluting 100 parts of acrylate-based ultraviolet curable resin coating material (Beamset NOP-102 (trade name); manufactured by Arakawa Chemical Industry Co., Ltd.) containing silica fine particles (average particle diameter: 100 nm) of the present invention with 1-methoxy-2-propanol.

### [Production of Hard Coat Film]

A hard coat film of Example 4 was produced in the same manner as in Example 1 except that the coating material for the easy-bonding layer including the above-mentioned composition was used.

### Example 5

### [Preparation of Coating Material for Hard Coat]

A coating material for a hard coat having a final solid content concentration of 30% was prepared by blending 75 parts of acrylate-based ultraviolet curable resin (NK ester A-9550 (trade name); manufactured by Shin-Nakamura Chemical Co., Ltd.) as a main agent, 10 parts of benzotriazole-based ultraviolet absorbing agent of the present invention (Tinuvin 970 (trade name); manufactured by BASF. Maximum absorption wavelength; 378 nm), 3.5 parts of IRGACURE 184 (photopolymerization initiator, manufactured by BASF), 0.5 parts of surface modifier (Ftergent 681; manufactured by NEOS Company Limited), 10 parts of hydroxyphenyl triazine-based ultraviolet absorbing agent (Tinuvin 477 (trade name); manufactured by BASF), and 1.0 part of cyanine dye of the present invention (NK-9994 (trade name); manufactured by Hayashibara Co., Ltd.) of the present invention, and diluting with toluene/methyl ethyl ketone/propylene glycol monomethyl ether acetate=15/35/50 (parts by weight).

### [Production of Hard Coat Film]

A hard coat film of Example 5 was produced in the same manner as in Example 1 except that the coating material for a hard coat including the above-mentioned composition was used.

### Example 6

### [Preparation of Coating Material for Hard Coat]

A coating material for a hard coat having a final solid content concentration of 30% was prepared by blending 74 parts of an acrylate-based ultraviolet curable resin (NK ester A-9550 (trade name); manufactured by Shin-Nakamura Chemical Co., Ltd.) as a main agent, 10 parts of the benzotriazole-based ultraviolet absorbing agent of the present invention (Adeka Stab LA-29 (trade name); manufactured by ADEKA. Maximum absorption wavelength; 350 nm), 3.5 parts of IRGACURE 184 (photopolymerization initiator, manufactured by BASF), 0.5 parts of surface modifier (Ftergent 681; manufactured by NEOS Company Limited), 10 parts of hydroxyphenyl triazine-based ultraviolet absorbing agent of the present invention (Tinuvin 477 (trade name); manufactured by BASF), 2.0 parts of cyanine dye of the present invention (NK-9994 (trade name); manufactured by Hayashibara Co., Ltd.), and diluting with toluene/methyl ethyl ketone/propylene glycol monomethyl ether acetate=15/35/50 (parts by weight).

### [Production of Hard Coat Film]

A hard coat film of Example 6 was produced in the same manner as in Example 1 except that the coating materials for hard coat including the above-mentioned compositions were used.

### Example 7

A hard coat film of Example 7 was produced in the same manner as in Example 1 except that the cyanine dye of the present invention (NK-9994 (trade name); manufactured by Hayashibara Co., Ltd.) in the coating material for a hard coat of Example 1 was changed to the cyanine dye of the present invention (NK-10490 (trade name); manufactured by Hayashibara Co., Ltd., maximum absorption wavelength; 405 nm), and the as a cycloolefin film was changed to a ZEONOR film ZD12 (manufactured by Zeon Corporation) having a thickness of 22 μm.

### Example 8

A hard coat film of Example 8 was produced in the same manner as in Example 1 except that the coating film thickness of the easy-bonding layer in Example 1 was changed to 1.8 μm.

### Example 9

A hard coat film of Example 9 was produced in the same manner as in Example 1 except that the coating thickness of the hard coat layer in Example 1 was changed to 8.0 μm.

### Comparative Example 1

### [Preparation of Coating Material for Hard Coat]

A coating material for a hard coat having a final solid content concentration of 30% was prepared by blending 96 parts of acrylate-based ultraviolet curable resin (NK ester A-9550 (trade name); manufactured by Shin-Nakamura Chemical Co., Ltd.) as a main agent, 3.5 parts of IRGACURE 184 (a photopolymerization initiator, manufactured by BASF), and 0.5 parts of a surface modifier (Ftergent 681; manufactured by NEOS Company Limited), diluting with toluene/methyl ethyl ketone/propylene glycol monomethyl ether acetate=15/35/50 (parts by weight).

### [Production of Hard Coat Film]

A hard coat film of Comparative Example 1 was produced in the same manner as in Example 1 except that the coating materials for a hard coat including the above-mentioned compositions were used.

### Comparative Example 2

### [Preparation of Coating Material for Hard Coat]

A coating material for a hard coat having a final solid content concentration of 30% was prepared by blending 75 parts of an acrylate-based ultraviolet curable resin (NK ester A-9550 (trade name); manufactured by Shin-Nakamura Chemical Co., Ltd.) as a main agent, 10 parts of dihydroxybenzophenone-based ultraviolet absorbing agent (Uvinul 3050 (trade name); manufactured by BASF. Maximum absorption wavelength; 345 nm), 3.5 parts of IRGACURE 184 (photopolymerization initiator, manufactured by BASF), 0.5 parts of surface modifier (Ftergent 681; manufactured by NEOS Company Limited), 10 parts of hydroxyphenyl triazine-based ultraviolet absorbing agent (Tinuvin 477 (trade name); manufactured by BASF), and 1.0 part of cyanine dye (NK-9994 (trade name); manufactured by Hayashibara Co., Ltd.), and diluting with toluene/methyl ethyl ketone/propylene glycol monomethyl ether acetate=15/35/50 (parts by weight).

### [Production of Hard Coat Film]

A hard coat film of Comparative Example 2 was produced in the same manner as in Example 1 except that the coating materials for hard coat including the above-mentioned composition were used and that the cycloolefin film of Example 1 was changed to a ZEONOR film ZF16 having a thickness of 50 μm (manufactured by Zeon Corporation).

### Comparative Example 3

### Preparation of Coating Material for Hard Coat

A coating material for a hard coat having a final solid content concentration of 30% was prepared by blending 80 parts of acrylate-based ultraviolet curable resin coating material containing a benzotriazole-based ultraviolet absorbing agent (HFC-UVA-1 (trade name); manufactured by Halima Kasei Co., Ltd. Maximum absorption wavelength of the benzotriazole-based ultraviolet absorbing agent: 370 nm), as a main material, and 3.5 parts of IRGACURE 184 (photopolymerization initiator, manufactured by BASF), 0.5 parts of surface modifier (Ftergent 681; manufactured by NEOS Company Limited), and 10 parts of hydroxyphenyl triazine-based ultraviolet absorbing agent (Tinuvin 477 (trade name); manufactured by BASF. Maximum absorption wavelength: 356 nm), and 6 parts of merocyanine dye (FDB-009 (trade name); manufactured by YAMADA CHEMICAL CO., LTD. Maximum absorption wavelength; 402 nm), and diluting with toluene/methyl ethyl ketone/propylene glycol monomethyl ether acetate=15/35/50 (parts by weight).

### [Production of Hard Coat Film]

A hard coat film of Comparative Example 3 was produced in the same manner as in Example 1 except that the coating material for a hard coat including the above-mentioned composition was used.

### Comparative Example 4

### [Preparation of Coating Material for Easy-Bonding Layer]

A coating material for an easy-bonding layer having a solid content concentration of 10% was prepared by diluting 100 parts of acrylate-based ultraviolet curable resin coating material (Luxidia EPS-1306 (trade name); manufactured by DIC) that does not contain silica fine particles with methyl ethyl ketone/1-methoxy-2-propanol=50/50 (parts by weight).

### [Production of Hard Coat Film]

A hard coat film of Comparative Example 4 was produced in the same manner as in Example 1 except that the coating material for the easy-bonding layer including the above-mentioned composition was used.

### Comparative Example 5

### [Preparation of Coating Material for Easy-Bonding Layer]

A coating material for an easy-bonding layer having a solid content concentration of 10% was prepared by diluting 100 parts of polyolefin-based resin as a thermoplastic resin (SURFLEN P-1000 (trade name), manufactured by Mitsubishi Chemical Co., Ltd.) with butyl acetate.

### [Production of Hard Coat Film]

A hard coat film of Comparative Example 5 was produced in the same manner as in Example 1 except that the coating material for the easy-bonding layer including the above-mentioned compositions were used.

### <Evaluation>

The hard coat films of Examples and Comparative Examples produced as mentioned above were evaluated in terms of the following items and the results are summarized in Table 1, Table 2, and Table 3.

### <Thickness of Coating Film>

Thicknesses of formation of a coating film of easy-bonding layers and hard coat layers were measured using a Thin-Film Analyzer F20 (trade name) (manufactured by FILMETRICS).

### <Adhesion (Initial Adhesion)>

The adhesion was evaluated by a crosscut peeling test in accordance with the crosscut method of JIS-K5600 May 6. Specifically, for each of the hard coat films produced in Examples and Comparative Examples, under normal environment, that is, under a constant temperature and humidity environment (25° C., 50% RH), 11 vertical and 11 horizontal cuts were made at intervals of 1 mm in a grid pattern on the hard coat layer-forming surface using a cutter knife to carve 100 square grids in total. Then, adhesive tape No. 252 manufactured by Sekisui Chemical Industry Co., Ltd. was stuck on it, pressed uniformly with a spatula, and peeled off in the direction of 180 degrees. Then, the remaining number of hard coat layers was set as the residual rate (%).

Note here that for the initial adhesion of the easy-bonding layer, the peeling test was carried out on the easy-bonding layer coated film.

### <Solvent Resistance>

The solvent resistance each of the cycloolefin polymer film alone used in Examples and Comparative Examples, or each easy-bonding layer coated film produced in Examples and Comparative Examples was evaluated as follows: toluene was dropped onto the surface so as to be a diameter of about 10 mm, and after 3 minutes, the dripped toluene was wiped off with gauze, and the appearance of the chemical dropped surface was visually evaluated. Evaluated products marked with “O” were evaluated to have good solvent resistance.
◯: No change in appearance of chemical dropped surface
X: Change in appearance of chemical dropped surface

### <b* Value>

A b* value was determined for each hard coat film produced in Examples and Comparative Examples using a spectrophotometer U-3310 manufactured by Hitachi High Technologies Corporation.

### <Light Transmittance at Each Wavelength>

Light transmittance at each wavelength of the hard coat film was measured using a spectrophotometer U-3310 manufactured by Hitachi High Technologies Corporation. The measurement was carried out at a wavelength ranging from 250 nm to 800 nm and at scanning speed of 600 nm/min, and light transmittance of each wavelength was detected followed by calculating a “light reduction rate in each wavelength (%)” shown in the following formula 1. Note here that when the transmittance of the cycloolefin polymer film alone at the wavelength was 0.0%, light reduction rate in each wavelength was defined as 100%.

Light reduction rate (%) at each wavelength=(Transmittance of cycloolefin polymer film alone at the wavelength−Transmittance of hard coat film at the wavelength)/Transmittance of cycloolefin polymer film alone at the wavelength Formula 1)

### <Light Resistance Test>

Accelerated light resistance tests (conducted in accordance with JIS B 7751:2007 in the following conditions) were carried out on each hard coat film prepared in Examples and Comparative Examples using an ultraviolet carbon fade meter.

Light source: ultraviolet rays carbon arc lamp

Temperature: 63° C.

Relative humidity: 50%

Irradiance: 500 W/m²

Radiation time: 100 hours

Rainfall period and time: not set

<Adhesion after Light Resistance Test>

The adhesion after the light resistance test was carried out by a crosscut test, and the number of residual hard coat layers was regarded as the residual rate (%). Note here that the adhesion after the light resistance test of the easy-bonding layer was carried out by a peeling test of the hard coat film provided with the hard coat layer on the easy-bonding layer to determine a peeling of the easy-bonding layer when the peeling occurred in, for example, easy-bonding layer.

### <Change Rate of Light Transmittance at Each Wavelength>

The change rate of the light transmittance at each wavelength of the hard coat film after light resistance test was measured under the same conditions using a spectrophotometer U-3310 similar to the rate of light transmittance at each wavelength to detect of the hard coat film after detecting the rate of light transmittance at each wavelength, and then, the “change rate (Δ%) of light transmittance at each wavelength” shown in the following Formula 2 was calculated. Note here that when the change rate became minus, the value was evaluated as an absolute value.

Change rate (Δ%) of light transmittance at each wavelength=Transmittance of hard coat film at the wavelength after light resistance test−Transmittance of hard coat film at the wavelength before light resistance test Formula 2)

TABLE 1

| | Cycloolefin | Easy-bonding layer | | | | Hard coat layer | | |
|---|---|---|---|---|---|---|---|---|
| | film | | | Residual rate | | | | Residual rate |
| | Solvent | | Residual | after light | Solvent | | Residual | after light |
| | resistance | Thickness | rate | resistance test | resistance | Thickness | rate | resistance |
| Table 1 | (toluene) | (μm) | (%) | (%) | (toluene) | (μm) | (%) | test (%) |
| Ex. 1 | X | 0.2 | 100 | 100 | ◯ | 4.5 | 100 | 100 |
| Ex. 2 | X | 0.2 | 100 | 100 | ◯ | 4.5 | 100 | 100 |
| Ex. 3 | X | 0.2 | 100 | 100 | ◯ | 4.5 | 100 | 100 |
| Ex. 4 | X | 0.2 | 100 | 100 | ◯ | 4.5 | 100 | 100 |
| Ex. 5 | X | 0.2 | 100 | 100 | ◯ | 4.5 | 100 | 100 |
| Ex. 6 | X | 0.2 | 100 | 100 | ◯ | 4.5 | 100 | 100 |
| Ex. 7 | X | 0.2 | 100 | 100 | ◯ | 4.5 | 100 | 100 |
| Ex. 8 | X | 1.8 | 100 | 100 | ◯ | 4.5 | 100 | 100 |
| Ex. 9 | X | 0.2 | 100 | 100 | ◯ | 8.0 | 100 | 100 |
| Co. Ex. 1 | X | 0.2 | 100 | 100 | ◯ | 4.5 | 100 | 100 |
| Co. Ex. 2 | X | 0.2 | 100 | 100 | ◯ | 4.5 | 100 | 100 |
| Co. Ex. 3 | X | 0.2 | 100 | 100 | ◯ | 4.5 | 100 | 100 |
| Co. Ex. 4 | X | 0.2 | 0 | 0 | ◯ | 4.5 | 0 | 0 |

| | | | | | | |
|---|---|---|---|---|---|---|
| Co. Ex. 5 | X | 0.2 | 100 | 100 | X | coating was impossible |

Ex = Example,
Co. Ex. = Comparative Example

TABLE 2

| | b* | Light reduction rate (%) at each wavelength | | | | | | | | | | |
|---|---|---|---|---|---|---|---|---|---|---|---|---|
| Table 2 | value | 350 nm | 360 nm | 370 nm | 380 nm | 390 nm | 400 nm | 410 nm | 420 nm | 430 nm | 440 nm | 450 nm |
| Ex. 1 | 5.8 | 100.0 | 100.0 | 100.0 | 100.0 | 99.9 | 99.5 | 96.2 | 67.3 | 22.7 | 5.4 | 1.2 |
| Ex. 2 | 6.8 | 100.0 | 100.0 | 100.0 | 100.0 | 100.0 | 99.8 | 97.8 | 73.0 | 26.2 | 6.7 | 2.0 |
| Ex. 3 | 5.9 | 100.0 | 100.0 | 100.0 | 100.0 | 100.0 | 99.5 | 95.5 | 60.0 | 23.2 | 5.3 | 1.5 |
| Ex. 4 | 6.3 | 100.0 | 100.0 | 100.0 | 100.0 | 99.9 | 99.8 | 97.6 | 63.3 | 20.1 | 4.9 | 1.8 |
| Ex. 5 | 6.9 | 100.0 | 100.0 | 100.0 | 100.0 | 99.7 | 99.0 | 95.2 | 74.5 | 28.9 | 6.8 | 1.5 |
| Ex. 6 | 2.8 | 100.0 | 100.0 | 100.0 | 100.0 | 98.1 | 98.5 | 96.2 | 61.3 | 25.3 | 4.4 | 0.7 |
| Ex. 7 | 5.8 | 100.0 | 100.0 | 100.0 | 100.0 | 99.9 | 99.5 | 96.5 | 61.2 | 21.3 | 5.3 | 1.6 |
| Ex. 8 | 5.7 | 100.0 | 100.0 | 100.0 | 100.0 | 99.8 | 99.0 | 95.3 | 60.0 | 19.0 | 6.0 | 2.0 |
| Ex. 9 | 7.0 | 100.0 | 100.0 | 100.0 | 100.0 | 100.0 | 100.0 | 97.7 | 70.2 | 23.2 | 6.9 | 2.0 |
| Co. Ex. 1 | 0.4 | 100.0 | 100.0 | 100.0 | 0.0 | 0.1 | 0.0 | 0.0 | 0.1 | 0.0 | 0.0 | 0.1 |
| Co. Ex. 2 | 1.8 | 97.8 | 96.7 | 89.1 | 85.8 | 80.4 | 71.1 | 69.2 | 26.9 | 7.0 | 3.0 | 1.6 |
| Co. Ex. 3 | 9.6 | 100.0 | 100.0 | 100.0 | 100.0 | 98.4 | 97.5 | 94.0 | 72.9 | 31.7 | 8.9 | 2.8 |
| Co. Ex. 4 | 6.0 | 100.0 | 100.0 | 100.0 | 100.0 | 99.9 | 99.4 | 94.0 | 62.0 | 22.0 | 5.0 | 1.0 |

Ex = Example
Co. Ex. = Comparative Example

TABLE 3

| | Change rate (Δ%) of light transmittance at each wavelength after light resistance test | | | | | | | | | | |
|---|---|---|---|---|---|---|---|---|---|---|---|
| Table 3 | 350 nm | 360 nm | 370 nm | 380 nm | 390 nm | 400 nm | 410 nm | 420 nm | 430 nm | 440 nm | 450 nm |
| Ex. 1 | 0.0 | 0.0 | 0.0 | 0.0 | 0.2 | 2.5 | 10.9 | 14.0 | 4.3 | 0.3 | 0.9 |
| Ex. 2 | 0.0 | 0.0 | 0.0 | 0.0 | 0.1 | 0.7 | 6.4 | 15.1 | 5.9 | 0.9 | 0.4 |
| Ex. 3 | 0.0 | 0.0 | 0.0 | 0.0 | 0.1 | 1.5 | 11.0 | 14.5 | 5.1 | 0.2 | 0.5 |
| Ex. 4 | 0.0 | 0.0 | 0.0 | 0.0 | 0.2 | 2.0 | 8.5 | 16.0 | 6.0 | 0.7 | 1.0 |
| Ex. 5 | 0.0 | 0.0 | 0.0 | 0.0 | 0.7 | 5.1 | 8.8 | 20.0 | 8.7 | 4.2 | 1.5 |
| Ex. 6 | 0.0 | 0.0 | 0.0 | 0.0 | 0.2 | 8.8 | 28.5 | 29.0 | 4.3 | 0.0 | 0.0 |
| Ex. 7 | 0.0 | 0.0 | 0.0 | 0.0 | 0.2 | 2.5 | 10.9 | 14.0 | 4.3 | 0.3 | 0.9 |
| Ex. 8 | 0.0 | 0.0 | 0.0 | 0.0 | 0.1 | 3.0 | 12.0 | 15.0 | 5.0 | 1.0 | 1.0 |
| Ex. 9 | 0.0 | 0.0 | 0.0 | 0.0 | 0.1 | 0.5 | 14.0 | 29.0 | 9.0 | 4.5 | 4.5 |
| Co. Ex. 1 | 0.0 | 0.0 | 0.0 | 0.0 | 0.0 | 0.1 | 0.0 | 0.0 | 0.1 | 0.0 | 0.0 |
| Co. Ex. 2 | 0.1 | 0.1 | 0.0 | 0.5 | 2.0 | 13.5 | 31.7 | 12.9 | 0.3 | 0.0 | 0.1 |
| Co. Ex. 3 | 0.0 | 0.0 | 0.0 | 0.0 | 5.7 | 38.5 | 61.2 | 55.7 | 24.5 | 5.9 | 1.1 |
| Co. Ex. 4 | 0.0 | 0.0 | 0.0 | 0.0 | 0.1 | 2.5 | 12.0 | 14.0 | 4.0 | 0.3 | 0.1 |

Ex = Example
Co. Ex. = Comparative Example

As is apparent from the results of Table 1, the hard coat films of Examples 1 to 9 of the present invention and Comparative Examples 1 to 3 using the easy-bonding layer including an ultraviolet curable resin containing silica fine particles are excellent in both the initial adhesion and the light-resistance adhesion (the adhesion after the light resistance test). Use of the easy-bonding layer including an ultraviolet curable resin containing silica fine particles can form a hard coat layer that is excellent in the adhesion (the initial adhesion and the light-resistance adhesion) even with respect to a base material film having few polar groups such as a cycloolefin polymer film and poor adhesion with respect to the hard coat layer. In other words, according to the present invention, a cycloolefin polymer-based film is used as a base material, and it is possible to obtain a hard coat film having excellent adhesion (the initial adhesion and the light-resistance adhesion) to the easy-bonding layer and the hard coat layer provided on the base material film with few polar groups and poor adhesion with respect to the base material.

Note here that in Comparative Example 4 of Table 1, the easy-bonding layer residual rate, the residual rate after the light resistance test, the hard coat layer residual rate, and the residual rate after light resistance test are all 0%, which means that peeling occurs in the easy-bonding layer. When peeling occurs in the easy-bonding layer, the hard coat layer on the easy-bonding layer is peeled off together.

Furthermore, Table 1 shows evaluation results of the solvent resistance of the cycloolefin polymer film and the easy-bonding layer. Since a hydrocarbon solvent such as toluene is used as a good solvent for an ultraviolet absorbing agent and a dye used in the hard coat layer including an ultraviolet curable resin containing an ultraviolet absorbing agent and a dye of the present invention, it is necessary to blend a hydrocarbon solvent such as toluene into the coating material for a hard coat. Since the cycloolefin polymer film used in the present invention has poor solvent resistance to a hydrocarbon solvent such as toluene and dissolves easily, it is difficult to obtain a good coating appearance because chemical cracks occur in a case where the coating material for a hard coat is directly coated. Thus, the easy-bonding layer including an ultraviolet curable resin containing inorganic fine particles (silica fine particles in Examples) of the present invention is excellent in solvent resistance to the hydrocarbon solvent such as toluene, even if the coating material for a hard coat containing a hydrocarbon solvent such as toluene is directly applied, excellent coating appearance can be obtained. However, in Comparative Example 5 using an easy-bonding layer including a thermoplastic resin, unlike the easy-bonding layer including an ultraviolet curable resin containing inorganic fine particles of the present invention, the solvent resistance against a hydrocarbon solvent such as toluene cannot be improved, and therefore, when coating material for a hard coat containing a hydrocarbon solvent such as toluene is applied, a good coating appearance cannot be obtained, thus making it difficult to produce a hard coat film.

As is apparent from the results of Table 2, the hard coat film of the present invention includes a hard coat layer including an ultraviolet curable resin containing the ultraviolet absorbing agent and the dye, and satisfies predetermined optical property of the present invention, that is, the above-mentioned conditions (E) to (P) of the present invention. Thus, the hard coat film of the present invention suppresses the b* value serving as an indicator of yellowness, does not cause an adverse effect on the color of a display of an organic EL display, and can achieve the light reduction rate at a wavelength from 350 nm to 400 nm, causing deterioration of some polymers or damage such as fading and discoloration of dye, of 95% or more and can suppress damages such as deterioration of some polymers or damage such as fading and discoloration of a dye. Furthermore, in recent years, for the purpose of improving durability (light resistance) of a light emitting element of the organic EL display, it has been required to sufficiently reduce the light transmittance at 390 nm to 410 nm to protect the light emitting element. In the hard coat film of the present invention, the light reduction rate at a wavelength from 390 nm to 410 nm can be 95% or more, the durability (light resistance) of the light emitting element of the organic EL display of recent years can be improved. On the other hand, the wavelength of 420 nm to 450 nm in the visible light range is required to have a reduced light reduction rate as much as possible to secure the brightness of the display of the organic EL display. The hard coat film of the present invention can suppress the light reduction rate of the wavelength of 420 nm to 450 nm, and does not adversely affect the brightness of the display of the organic EL display.

As is apparent from the results of Table 3, the hard coat film of the present invention includes a hard coat layer including ultraviolet curable resin containing the ultraviolet absorbing agent and the dye, and satisfies the optical property of the present invention, that is, the above-mentioned conditions (Q) to (AA) even after the light resistance test. The transmittance at each wavelength, from the purpose thereof, is required to be maintained also after light resistance test, at a wavelength of 350 nm to 400 nm, causing deterioration of some polymers or damage such as fading and discoloration of dye, and at a wavelength of 390 nm to 410 nm contributing to protection of the light emitting element of the recent organic EL display. Since the hard coat film of the present invention can suppress the change rate of the light transmittance at a wavelength of 350 nm to 400 nm and at a wavelength of 390 nm to 410 nm, deterioration of the display of the organic EL display can be suppressed. Furthermore, also at a wavelength of 420 nm to 450 nm in the visible light range, the performance is required to be maintained also after light resistance test, but the hard coat film of the present invention can suppress the change rate of the light transmittance, and maintain the brightness of the display of the organic EL display.

On the other hand, in Comparative Example 1 using a hard coat layer including ultraviolet curable resin that contains neither an ultraviolet absorbing agent nor a dye, the transmittance at 380 nm to 410 nm cannot be reduced, causing deterioration of the display of the organic EL display. Furthermore, in Comparative Example 2 using an ultraviolet absorbing agent that is a different type of the ultraviolet absorbing agent from the ultraviolet absorbing agent preferably used in the present invention, the light reduction rate at each wavelength is insufficient, and the change rate of the light transmittance at each wavelength after light resistance test is large, and display of the organic EL display is deteriorated and durability (light resistance) of the light emitting element cannot be improved. Furthermore, in Comparative Example 3 using a dye that is a different type of dye from the dye preferably used in the present invention, although the light reduction rate in each wavelength is acceptable, a b* value serving as an indicator of yellowness is high, which adversely affects the color of display of the organic EL display, and the change rate of the light transmittance at each wavelength after light resistance test is very large, and improvement of the durability (light resistance) of the light emitting element of the organic EL display cannot be achieved. On the other hand, in Comparative Example 4 that does not use the easy-bonding layer including an ultraviolet curable resin containing inorganic fine particles of the present invention (that is, ultraviolet curable resin that does not contain inorganic fine particles), adhesion with respect to the base material film is poor (see Table 1), and a hard coat layer including an ultraviolet curable resin containing an ultraviolet absorbing agent and a dye lacks, so that protection of the organic EL display cannot be achieved.

1: A hard coat film comprising:
a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles,
the hard coat film satisfying the following conditions (A) to (D):
(A) a thickness of the easy-bonding layer is in a range from 0.1 μm to 2.0 μm;
(B) a thickness of the hard coat layer is in a range from 1.0 μm to 10.0 μm;
(C) residual rates of the hard coat layer and the easy-bonding layer in the hard coat film, measured by a crosscut method according to JIS-K5600 May 6, are both 100%; and
(D) residual rates of the hard coat layer and the easy-bonding layer, measured by a crosscut method according to JIS-K5600 May 6, after the hard coat film is subjected to ultraviolet radiation as a light resistance test for 100 hours in an environment at a temperature of 63° C., at a relative humidity of 50%, and with irradiance of 500 W/m², are both 100%.

2: The hard coat film according to claim 1, wherein the hard coat film further satisfies the following condition (E), and a light reduction rate (%) at each wavelength, calculated from the following formula 1, satisfies the following conditions (F) to (P):
(E) a b* value is 7.0 or less,
Light reduction rate (%) at each wavelength=(Transmittance of the cycloolefin polymer-based film alone at the wavelength−Transmittance of the hard coat film at the wavelength)/Transmittance of the cycloolefin polymer-based film alone at the wavelength Formula 1)
(F) a light reduction rate at a wavelength of 350 nm is 95.0% or more,
(G) a light reduction rate at a wavelength of 360 nm is 95.0% or more,
(H) a light reduction rate at a wavelength of 370 nm is 95.0% or more,
(I) a light reduction rate at a wavelength of 380 nm is 95.0% or more,
(J) a light reduction rate at a wavelength of 390 nm is 95.0% or more,
(K) a light reduction rate at a wavelength of 400 nm is 95.0% or more,
(L) a light reduction rate at a wavelength of 410 nm is 95.0% or more,
(M) a light reduction rate at a wavelength of 420 nm is 75.0% or less,
(N) a light reduction rate at a wavelength of 430 nm is 30.0% or less,
(O) a light reduction rate at a wavelength of 440 nm is 7.0% or less, and
(P) a light reduction rate at a wavelength of 450 nm is 2.0% or less.

3: The hard coat film according to claim 1, wherein after the hard coat film is subjected to ultraviolet radiation as a light resistance test for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):
Formula 2) Change rate (Δ%) of light transmittance at each wavelength=Transmittance of the hard coat film at the wavelength after light resistance test−Transmittance of the hard coat film at the wavelength before light resistance test
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

4: The hard coat film according to claim 1, wherein a maximum absorption wavelength (Amax) of the ultraviolet absorbing agent is in a range from 350 nm to 380 nm, and a maximum absorption wavelength (Amax) of the dye is in a range from 395 nm to 415 nm.

5: The hard coat film according to claim 1, wherein as the ultraviolet absorbing agent, a benzotriazole-based ultraviolet absorbing agent and a hydroxyphenyl triazine-based ultraviolet absorbing agent are used in combination.

6: The hard coat film according to claim 1, wherein the dye is a cyanine dye.

7: A hard coat film comprising a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles,
the hard coat film satisfying the following condition (E), and a light reduction rate (%) of each wavelength calculated by the following Formula 1 satisfies the following conditions (F) to (P):
(E) a b* value is 7.0 or less,
Light reduction rate (%) at each wavelength=(Transmittance of the cycloolefin polymer-based film alone at the wavelength−Transmittance of the hard coat film at the wavelength)/Transmittance of the cycloolefin polymer-based film alone at the wavelength; Formula 1)
(F) a light reduction rate at a wavelength of 350 nm is 95.0% or more,
(G) a light reduction rate at a wavelength of 360 nm is 95.0% or more,
(H) a light reduction rate at a wavelength of 370 nm is 95.0% or more,
(I) a light reduction rate at a wavelength of 380 nm is 95.0% or more,
(J) a light reduction rate at a wavelength of 390 nm is 95.0% or more,
(K) a light reduction rate at a wavelength of 400 nm is 95.0% or more,
(L) a light reduction rate at a wavelength of 410 nm is 95.0% or more,
(M) a light reduction rate at a wavelength of 420 nm is 75.0% or less,
(N) a light reduction rate at a wavelength of 430 nm is 30.0% or less,
(O) a light reduction rate at a wavelength of 440 nm is 7.0% or less, and
(P) a light reduction rate at a wavelength of 450 nm is 2.0% or less.

8: The hard coat film according to claim 7, wherein after the hard coat film is subjected to ultraviolet radiation as a light resistance test for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):
Change rate (Δ%) of light transmittance at each wavelength=Transmittance of the hard coat film at the wavelength after light resistance test−Transmittance of the hard coat film at the wavelength before light resistance test Formula 2)
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

9: The hard coat film according to claim 7, wherein a maximum absorption wavelength (Amax) of the ultraviolet absorbing agent is in a range from 350 nm to 380 nm, and a maximum absorption wavelength (Amax) of the dye is in a range from 395 nm to 415 nm.

10: The hard coat film according to claim 7, wherein as the ultraviolet absorbing agent, a benzotriazole-based ultraviolet absorbing agent and a hydroxyphenyl triazine-based ultraviolet absorbing agent are used in combination.

11: The hard coat film according to claim 7, wherein the dye is a cyanine dye.

12: A hard coat film comprising: a hard coat layer including an ultraviolet curable resin, an ultraviolet absorbing agent, and a dye, the hard coat layer being stacked on at least one surface of a cycloolefin polymer-based film having a thickness of 50 μm or less via an easy-bonding layer including ultraviolet curable resin containing inorganic fine particles wherein after the hard coat film is subjected to ultraviolet radiation as a light resistance test for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):
Change rate (Δ%) of light transmittance at each wavelength=Transmittance of the hard coat film at the wavelength after light resistance test−Transmittance of the hard coat film at the wavelength before light resistance test Formula 2)
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

13: The hard coat film according to claim 12, wherein a maximum absorption wavelength (λmax) of the ultraviolet absorbing agent is in a range from 350 nm to 380 nm, and a maximum absorption wavelength (λmax) of the dye is in a range from 395 nm to 415 nm.

14: The hard coat film according to claim 12, wherein as the ultraviolet absorbing agent, a benzotriazole-based ultraviolet absorbing agent and a hydroxyphenyl triazine-based ultraviolet absorbing agent are used in combination.

15: The hard coat film according to claim 12, wherein the dye is a cyanine dye.

16: The hard coat film according to claim 2, wherein after the hard coat film is subjected to ultraviolet radiation as a light resistance test for 100 hours in an environment at a temperature of 63° C., at a relative humidity of 50%, and with irradiance of 500 W/m², an absolute value of a change rate (Δ%) of light transmittance at each wavelength, calculated by the following formula 2, satisfies the following conditions (Q) to (AA):
Change rate (Δ%) of light transmittance at each wavelength=Transmittance of the hard coat film at the wavelength after light resistance test−Transmittance of the hard coat film at the wavelength before light resistance test Formula 2)
(Q) an absolute value of a change rate of light transmittance at a wavelength of 350 nm is 1.0% or less;
(R) an absolute value of a change rate of light transmittance at a wavelength of 360 nm is 1.0% or less;
(S) an absolute value of a change rate of light transmittance at a wavelength of 370 nm is 1.0% or less;
(T) an absolute value of a change rate of light transmittance at a wavelength of 380 nm is 1.0% or less;
(U) an absolute value of a change rate of light transmittance at a wavelength of 390 nm is 5.0% or less;
(V) an absolute value of a change rate of light transmittance at a wavelength of 400 nm is 10.0% or less;
(W) an absolute value of a change rate of light transmittance at a wavelength of 410 nm is 30.0% or less;
(X) an absolute value of a change rate of light transmittance at a wavelength of 420 nm is 30.0% or less;
(Y) an absolute value of a change rate of light transmittance at a wavelength of 430 nm is 10.0% or less;
(Z) an absolute value of a change rate of light transmittance at a wavelength of 440 nm is 5.0% or less; and
(AA) an absolute value of a change rate of light transmittance at a wavelength of 450 nm is 5.0% or less.

17: The hard coat film according to claim 2, wherein a maximum absorption wavelength (λmax) of the ultraviolet absorbing agent is in a range from 350 nm to 380 nm, and a maximum absorption wavelength (λmax) of the dye is in a range from 395 nm to 415 nm.

18: The hard coat film according to claim 2, wherein as the ultraviolet absorbing agent, a benzotriazole-based ultraviolet absorbing agent and a hydroxyphenyl triazine-based ultraviolet absorbing agent are used in combination.

19: The hard coat film according to claim 2, wherein the dye is a cyanine dye.
